(19) United States
(12) Patent Application Publication
(10) Pub. No.: US 2009/0294595 A1
(43) Pub. Date: Dec. 3, 2009

(54) INFLATABLE CAPTURE DEVICE

(76) Inventors: Pasquale PELLEGRINO, Torino (IT); Marco NEBIOLO, Torino (IT); Maria Antonietta PERINO, Torino (IT); Monica SELENU, Torino (IT); Paolo PALMIERI, Torino (IT)

Correspondence Address: Steinfl & Bruno, 301 N Lake Ave Ste 810, Pasadena, CA, 91101, US

(21) Appl. No.: 12/431,250

(22) Filed: Apr. 28, 2009

(30) Foreign Application Priority Data
May 29, 2008 (EP) 08104167.5

(51) Int. Cl. B64G 1/64

(52) U.S. Cl. 244/172.4

(57) ABSTRACT

A capture device for capturing at least one free-flying body in space, to be installed onboard a space apparatus. The capture device comprises an inflatable primary body, a capture volume, which is at least partially defined by the inflatable primary body, and an inlet mouth cooperating with the capture volume. In particular, the free-flying body to be captured may pass through the inlet mouth, so that the capture volume may receive the body.

### CROSS REFERENCE TO RELATED APPLICATIONS

The present application claims priority to European Patent Application No. 08104167.5 filed on May 29, 2008, which is incorporated herein by reference in its entirety.

### FIELD

The present disclosure generally refers to the technical field of space applications, and more particularly, to a device for capturing free-flying bodies in space, as defined in the preamble of claim 1.

More in particular, the present disclosure relates to a capture device to be installed onboard a space apparatus, such as for example a space vehicle, for capturing free-flying bodies in space.

### BACKGROUND

Capture devices are known which use rather complex mechanical structures, such as for example robotic systems comprising mechanical arms controlled by a space vehicle, on which they are installed.

However, the devices of the known art have certain drawbacks.

In general, such devices are characterized by a rather large mass, a considerable volumetric bulk and very high complexity. This is particularly relevant for space applications, in which a greater mass with respect to payload causes a considerable increase of costs, and where the available volume at launch generally represents a critical parameter.

A further drawback of capture devices of the known art is related to the fact that such devices normally comprise a high number of electro-mechanical devices and sophisticated electronic units, which increase the complexity of the structure and of overall system management, therefore reducing its dependability.

### ABSTRACT

According to a first aspect, a capture device for capturing at least a free-flying body in space is provided, the device capable of being installed onboard a space apparatus and comprising: an inflatable primary body, a capture volume at least partially defined by the inflatable primary body, and an inlet mouth interacting with the capture volume, the inlet mouth being arranged to let the free-flying body to pass through the inlet mouth, allowing the capture volume to receive the free-flying body.

Further aspects of the present disclosure are disclosed in the specification, drawings and claims of the present application.

### BRIEF DESCRIPTION OF THE DRAWINGS

The disclosure will be better understood in the following detailed description of its embodiments, which are illustrative, and therefore not limiting, with reference to appended drawings, in which:

FIG. 1 shows a perspective view of a capture device according to an embodiment of the present disclosure;

FIG. 2 shows a front elevation view of capture device of FIG. 1;

FIG. 3 to 8 show front sectional views of capture device of FIG. 1, in different operating arrangements, corresponding to a capture sequence of a free-flying body in space;

FIG. 9 shows a perspective sectional view of a further embodiment of a capture device according to the present disclosure, wherein some elements have been omitted; and

FIG. 10 shows a perspective view of capture device of FIG. 9, in which some elements of said device are visible, which are not illustrated in FIG. 9.

### DETAILED DESCRIPTION

In the following description, same or like elements are provided with same numeral references in all figures.

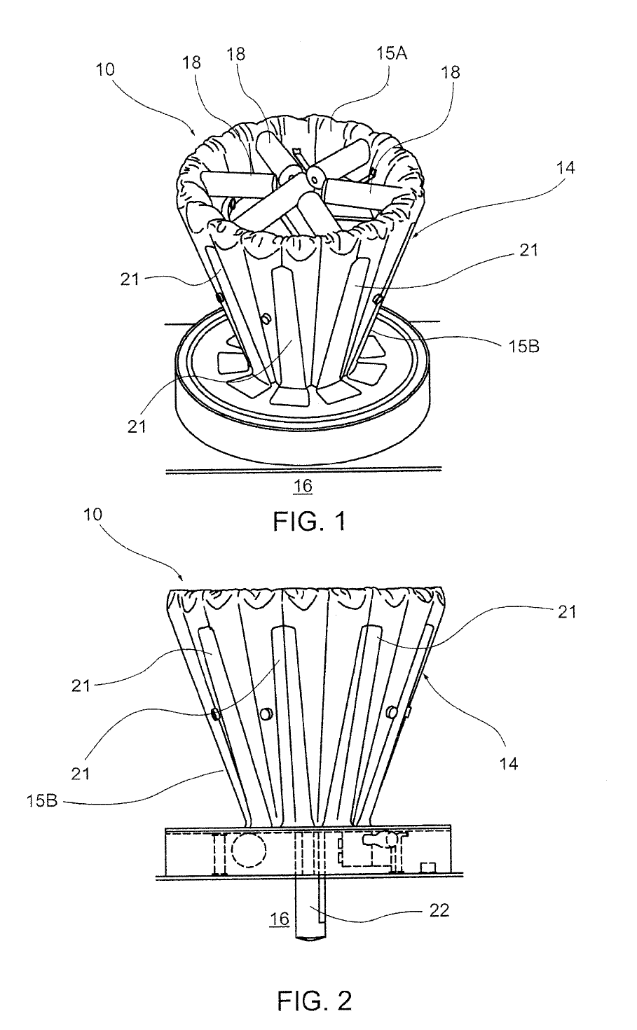

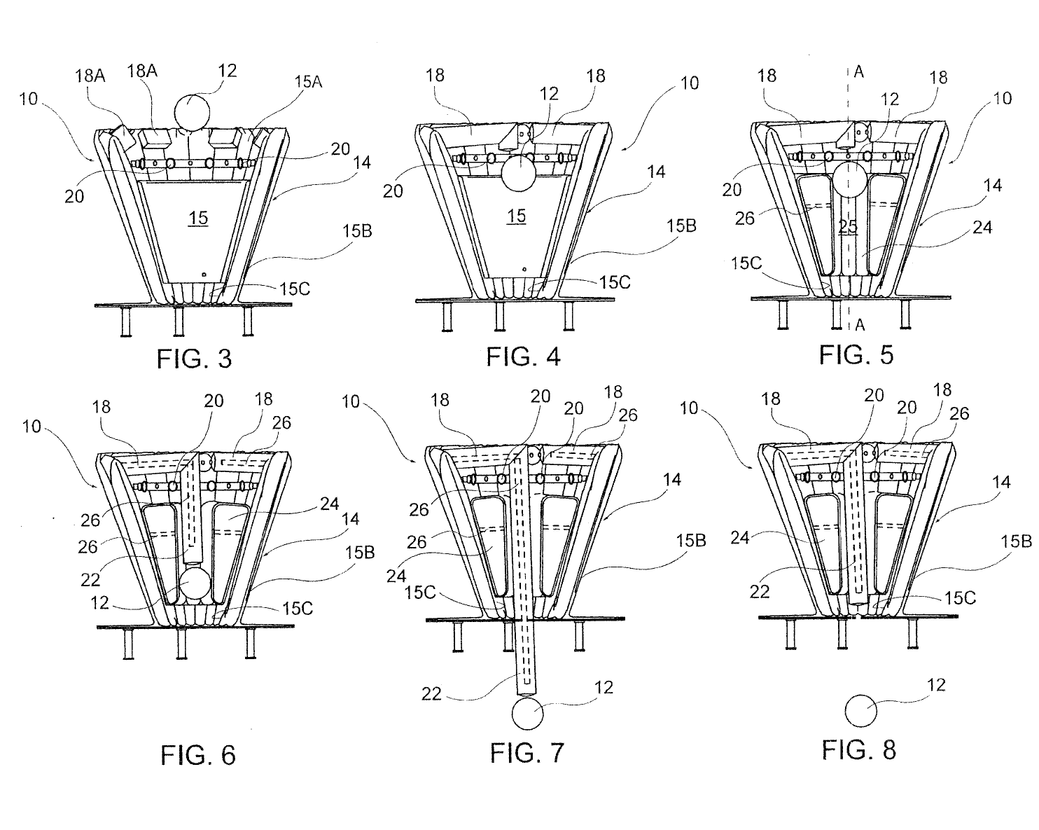

Initially, with reference to FIGS. 1 and 2, a capture device according to an embodiment of the present disclosure is generally shown at 10. The capture device 10 may be installed on board a space apparatus for capturing a generic free-flying body in space.

For such a device other types of use may also be envisaged, like for example meteorite trajectory deflection or out-of-service satellite reentry operations. The space apparatus provided with an onboard capture device 10 may for example be a space vehicle, such as a satellite, an orbiting space module, an orbiting space platform, a space shuttle, and similar. According to some embodiments, the space apparatus, on which the capture device 10 is installed, is a space vehicle adapted to orbit around a planet, such as a satellite.

In the examples shown, the free-flying body to be captured is a container 12, for collecting material samples, which are, for example, taken from the surface of a planet and which may be analyzed in a laboratory. However, the free-flying body may also be another kind of body or object in space, such as, for example, parts of abandoned space apparatuses, objects or apparatuses released by space vehicles, etc.

The capture device 10 comprises an inflatable primary body 14, which is provided, in some embodiments, in such a way as to comprise a single inflatable chamber, which may define, at least partially, a capture volume 15 (FIG. 3), for receiving the container 12.

In the embodiments shown in the figures, the primary body 14 has a substantially basket-like shape. The basket 14 comprises an inlet mouth 15A through which the container 12 may pass, so that said container may be received inside the capture volume 15.

The basket 14 has a converging shape, such as a substantially frusto-conical shape.

More in particular, in the embodiments shown in figures, the basket 14 converges according to a direction which goes from the inlet mouth 15A to a bottom portion 15B of basket 14.

In the exemplary embodiments, the basket, in its completely inflated arrangement, has a frusto-conical shape, which is characterized, in a non limiting way, by an angle of the cone of about 20°, a diameter of the inlet mouth 15A between around 600 mm and around 1000 mm and height between around 1000 mm and around 1300 mm.

According to other embodiments of the present disclosure, the primary body 14 may be, however, provided with a shape different from the shape of a frusto-conical basket, for example a cylindrical shape.

According to some embodiments, basket 14 comprises an outlet mouth 15C (FIG. 3) which is opposed to inlet mouth 15A. More in particular, the outlet mouth is positioned at the bottom portion 15B of basket 14.

According to a further embodiment of the disclosure, the outlet mouth 15C may communicate with a storage volume 16, which may house the container 12, once the capture phase has been completed. In some embodiments, the storage volume 16 is defined by a suitable enclosure, which is positioned, with respect to outlet mouth 15C, on the side opposite to capture volume 15.

According to another embodiment of the disclosure, capture device 10 comprises barrier means for trapping container 12 inside capture volume 15, once said container has passed through inlet mouth 15A of basket 14. In practice, barrier means are such as to obstruct, at least partially, inlet mouth 15A, in order to prevent container 12, after being received inside capture volume 15, to exit basket through this mouth, for instance, by bouncing off a portion of basket 14.

According to an additional embodiment, barrier means comprise a plurality of inflatable arms 18, which may move from a stand-by arrangement to an operating arrangement. In the stand-by arrangement, inflatable arms are deflated and, e.g., curled, each one in a respective housing seat 18A (FIG. 3). For example, each arm 18 may be suitably folded for allowing container 12 to pass through inlet mouth 15A of device 10.

In their operating arrangement, inflatable arms 18 are inflated, for example by means of a gas, and protrude from the basket 14.

According to a further embodiment, inflatable arms 18 are arranged along the inlet mouth of basket 14, for example in equally distanced angular positions, and protrude from basket, extending from its periphery towards the center of said mouth.

In the embodiments shown, in which the inlet mouth is substantially circular, inflatable arms 18 extend, in particular in a radial direction, from the periphery towards the center of said mouth.

According to an embodiment of the disclosure, the barrier means comprise auxiliary barrier means, for increasing the obstruction of inlet mouth 15A. The provision of auxiliary barrier means ensure that the container 12 may be trapped inside the capture volume 15, once the container is received inside said space and barrier means are activated. In other words, with reference to the embodiments shown, the auxiliary barrier means allow the container 12 to be trapped inside the capture volume 15, when inflatable arms 18 are disposed in their operating arrangement.

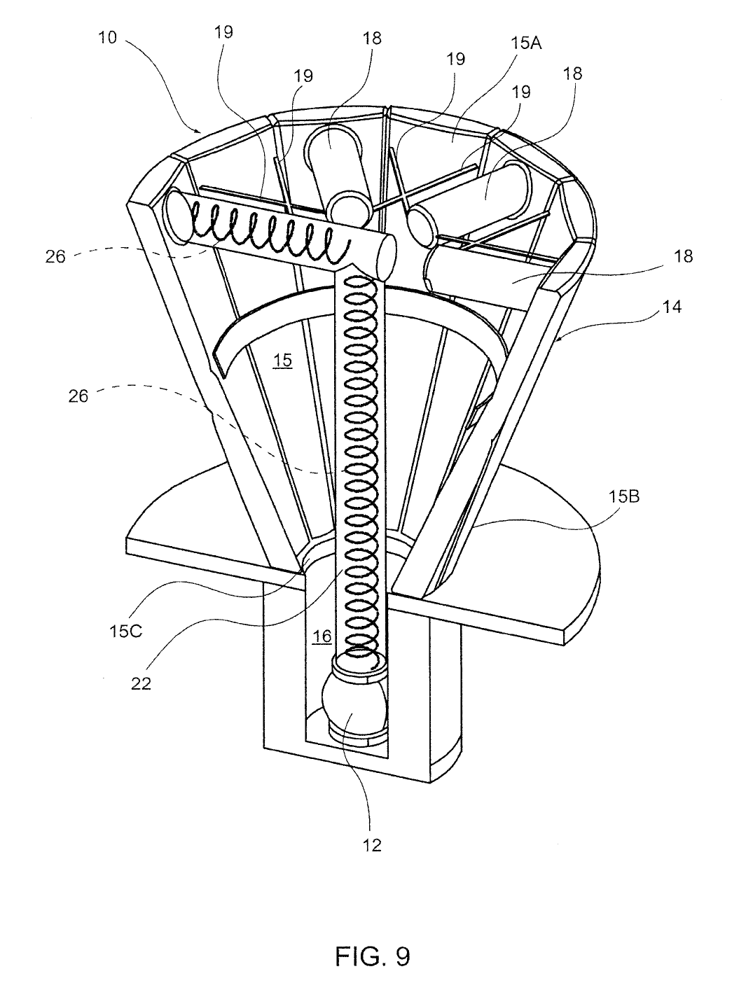

With reference to the embodiments shown in figures, the auxiliary barrier means comprise a plurality of bands or barrier belts 19 (clearly visible in FIG. 9), which extend between the inflatable arms 18 according to a generally net-like or web-like arrangement, when said arms are positioned in the operating arrangement. More in particular, according to an embodiment of the disclosure, the auxiliary barrier means comprise band pairs, positioned in an “X”-like arrangement, connected, in some embodiments, to each other or formed by a single “X”-shaped piece, wherein each band has an end fixed to the basket 14 and an opposite end connected to one of said inflatable arms 18.

The barrier bands 19, for example, prevent the container 12 from exiting the capture volume, by passing between two consecutive inflatable arms 18.

This may happen, if the size of container 12 is reduced to such an extent, allowing it to pass through the free space between said arms.

Therefore, bands 19 are sized, in some embodiments, according to size of container 12 and inlet mouth 15A of capture device 10, such as to ensure that container 12, once it has entered capture volume 15, is not able to exit said space.

The capture device 10 comprises a sensing system, for sensing the presence of container 12 inside capture volume 15, when said container passes through a sensing region, for example a sensing plane arranged transversally with respect to a symmetry axis of basket 14, which is directed along a line connecting the inlet mouth 15A to the outlet mouth 15C.

According to yet another embodiment of the disclosure, the sensing system comprises sensing means, which are disposed inside the capture volume 15. In the example shown in the figures, sensing means comprise a plurality of optoelectronic devices, such as photoelectric sensors 20 (FIG. 3), which are mounted on a supporting structure, provided on a wall of basket 14, which interacts with capture volume 15.

According to an embodiment of the disclosure, sensors 20 are provided downstream of the inflatable arms 18, looking from the inlet mouth 15A towards the bottom portion 15B of basket 14, i.e., in the incoming direction of container 12, when it enters capture volume 15.

According to an embodiment of the disclosure, the capture device 10 comprises cable protection pockets 21, which internally enclose electric cables for connecting sensors 20 and optional thermal components. Such protection pockets extend, in some embodiments, in a longitudinal direction, from inlet mouth 15A to outlet mouth 15C of basket 14, along a wall of basket, which is positioned on the opposite side of capture volume 15.

According to the embodiments shown, the capture device 10 comprises pushing means for pushing the container 12 towards the storage volume 16.

According to another embodiment of the disclosure, pushing means comprise an inflatable pushing portion 22, which is associated to one of inflatable arms 18. In particular, this pushing portion 22, in its inflated configuration, extends from its associated arm towards the outlet mouth 15C of basket 14. According to some embodiments, pushing portion 22, in its completely inflated configuration, extends from respective inflatable arm in such a way as to pass through the outlet mouth 15C of basket 14.

According to an embodiment of the present disclosure, the inflatable chamber of inflatable primary body 14 and the inflatable arms 18 are such as to be fluidly communicating with each other. Similarly, also pushing portion 22 and its associated inflatable arm may fluidly communicate with each other.

In particular, the inflatable chamber of primary body 14, the inflatable arms 18, and the pushing portion 22 have different inflation activation pressures.

In some embodiments, inflatable chamber of basket 14 and inflatable arms 18, as well as the pushing portion 22 and associated inflatable arm, are interconnected by means of suitable valve means (not shown). Such valve means may be activated when the inflatable chamber of basket 14 has reached a predetermined inflation pressure, in order to allow the following inflation of inflatable arms. Similarly, valve means provided between pushing portion 22 and respective inflatable arm may be activated when internal pressure of said arm reaches a predetermined threshold value, to therefore allow inflation of pushing portion 22.

Since the inflatable chamber of basket 14, the inflatable arms 18 and the pushing portion 22 may communicate with each other, and since different inflation triggering pressures are respectively set up, it is possible to inflate basket 14, inflatable arms 18 and pushing portion 22 according to a predetermined inflation sequence.

According to an embodiment of the disclosure, the capture device 10 includes inflatable guiding elements 24 (FIG. 5), which are provided inside capture volume 15 for guiding container 12 towards storage volume 16.

According to the embodiments shown, inflatable guiding elements 24 extend along a wall of basket 14 surrounding an axis AA (FIG. 5) of said basket. In some embodiments, axis AA is a symmetry axis of basket 14, which is directed along a line connecting the inlet mouth 15A with the outlet mouth 15C.

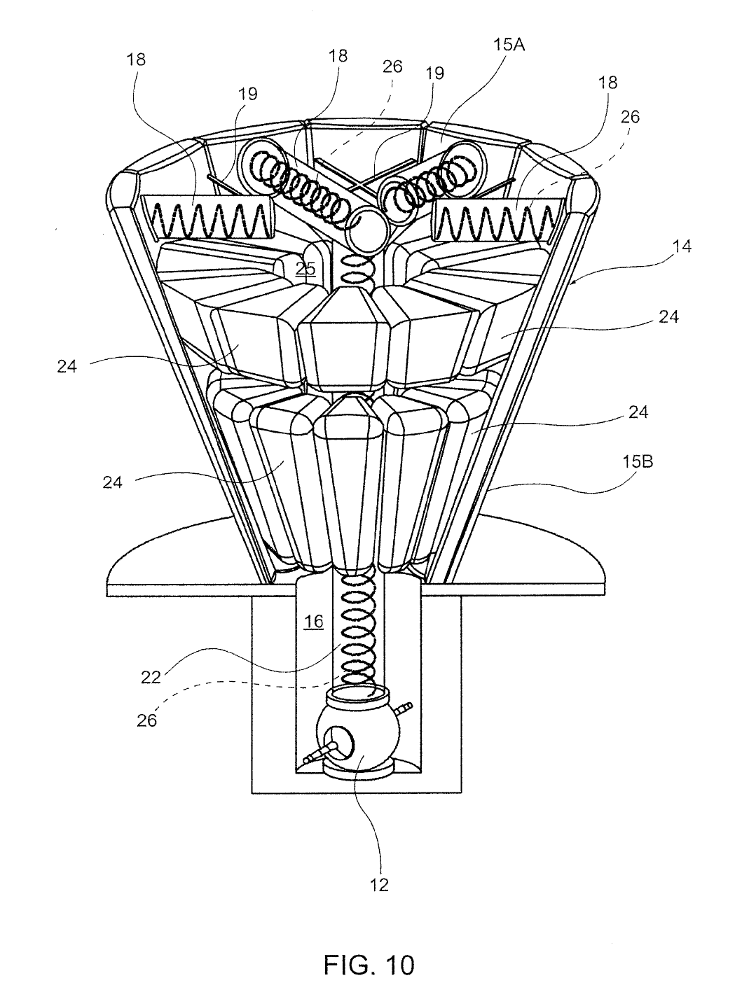

According to an embodiment of the disclosure, the inflatable guiding elements 24 comprise a single inflatable chamber (FIG. 5). However, according to another embodiment of the disclosure, inflatable guiding elements 24 may comprise a plurality of separate elements, each provided with a respective inflatable chamber (FIG. 10).

The inflatable guiding elements 24 are such as to define a guiding path or passage 25 (FIGS. 5 and 10), for guiding container 12 towards outlet mouth 15C of basket 14.

In some embodiments, guiding elements 24 are able to exert a centering action, in order to align container 12 with outlet mouth 15C, before and/or during the phase, in which the inflatable pushing portion 22 is pushing on said container.

With reference to the illustrated embodiments, the operation of a capture device 10 according to the present disclosure is described in the following.

Initially, basket 14 is deflated and in positioned in a curled configuration, for example is folded together, in a respective housing seat.

Shortly before start of capture phase, basket 14 is rapidly inflated by means of a suitable inflation apparatus, and is positioned, in some embodiments, so that inlet mouth 15A crosses the trajectory of container 12.

In this phase, inflatable arms 18 are in a stand-by arrangement. More in particular, inflatable arms 18 remain in the stand-by arrangement, until container 12, after passing through inlet mouth of basket 14, travels through sensing region defined by sensors 20.

When this takes place, sensors 20 send a signal for starting inflation of arms 18, of optional inflatable guiding elements 24, if present, and of pushing portion 22. According to an embodiment of the disclosure, the inflation sequence comprises a preliminary phase, in which arms 18 are inflated, followed by inflation of inflatable guiding elements 24 and final inflation of pushing portion 22. Due to preliminary inflation of inflatable arms 18 and, when present, the provision of optional barrier bands 19, a quick trapping of container 12 inside capture volume 15 is ensured, preventing it from exiting through inlet mouth 15A.

The pushing portion 22 progressively becomes inflated, passing through the guiding passage 25 defined by inflatable guiding elements 24, if present, pushing the container 12 towards the outlet mouth 15C, until it is guided into the storage volume 16. This pushing action on container 12 is particularly facilitated by the shape of the capture device, especially when inflatable guiding elements 24 are absent, since the container 12 is forced by the geometry of basket 14 to move towards the outlet mouth 15C, in order to be introduced into the storage volume 16.

Based on above description, it is therefore possible to understand how a capture device according to the present disclosure may solve above said drawbacks, with reference to the known art.

In particular, the provision of an inflatable capture device allows a significant reduction both of mass and bulk of such a device, and therefore a great reduction of costs, in particular of costs relating to same capture device.

Moreover, the provision of an inflatable capture device allows a conspicuous reduction of the number of electromechanical devices and electronic units required for command and control of such a device, therefore greatly improving the dependability of same device.

It is evident that modifications and/or variations may be introduced with respect to above described and illustrated example.

According to an embodiment of the disclosure, the capture device 10 comprises a rearm system, for implementing a multi-capture operating mode of said device.

In the embodiments shown, the rearm system includes a plurality of restoring means, which are associated to inflatable arms 18 and to inflatable pushing portion 22.

According to the embodiment shown in FIGS. 9 and 10, the restoring means comprise elastic restoring means, which are coil springs 26 in the example shown, and which are inserted inside each inflatable arm 18 and inside the inflatable pushing portion 22. However, according to other embodiments of the disclosure, the elastic restoring means may comprise, instead of springs, other types of components, such as elastic ropes.

In some embodiments, restoring means 26 are also provided inside the optional inflatable guiding elements 24.

When the inflatable arms 18 are in their stand-by position, the restoring springs 26 are in an unloaded state, whereas they are elastically loaded when inflatable arms are in their operating position. More in particular, when the inflatable arms 18 are inflated, and are moved from a stand-by position to an operating arrangement, the springs 26 counteract the inflation, and tend to return said arms in their stand-by position. When inflatable arms are depressurized, springs 26 are no more counterbalanced by gas pressure, allowing inflatable arms to return in their stand-by position. In this way, the capture device is now ready for a successive capture phase.

Accordingly, what has been shown is an inflatable capture device. While such inflatable capture device has been described by means of specific embodiments and applications thereof, it is understood that numerous modifications and variations could be made thereto by those skilled in the art without departing from the spirit and scope of the disclosure. It is therefore to be understood that within the scope of the claims, the disclosure may be practiced otherwise than as specifically described herein.

1. A capture device for capturing at least one free-flying body in space, the device capable of being installed onboard a space apparatus and comprising:
an inflatable primary body,
a capture volume at least partially defined by the inflatable primary body, and
an inlet mouth interacting with the capture volume, the inlet mouth being arranged to let the free-flying body to pass through the inlet mouth, allowing the capture volume to receive the free-flying body.

2. The capture device according to claim 1, further comprising
an outlet mouth, the outlet mouth being arranged so that the free-flying body may pass through the outlet mouth, for said free-flying body to be received inside a storage volume communicating with the outlet mouth.

3. The capture device according to claim 2, wherein the inflatable primary body has a shape converging along a direction extending from the inlet mouth towards the outlet mouth.

4. The capture device according to claim 3, wherein the inflatable primary body has a substantially frusto-conical shape.

5. The capture device according to claim 1, further comprising
barrier means for obstructing, at least partially, the inlet mouth in order to trap the free-flying body inside the capture volume.

6. The capture device according to claim 5, wherein the barrier means comprise a plurality of inflatable arms, the inflatable arms adapted to move from a stand-by arrangement, in which the inflatable arms are deflated and folded together, each inflatable arm being positioned in a respective seat, to an operating arrangement, in which the inflatable arms protrude from the inflatable primary body, in order to obstruct, at least partially, the inlet mouth.

7. The capture device according to claim 6, further comprising
auxiliary barrier means, for increasing obstruction of the inlet mouth in order to ensure trapping of the free-flying body inside the capture volume, wherein the auxiliary barrier means comprise a plurality of barrier bands, the barrier bands extending between inflatable arms, according to a generally net-like or web-like arrangement, when the inflatable arms are in their operating arrangement.

8. The capture device according to claim 5, further comprising
a sensing system for defining a sensing region, the sensing system sending a signal for activating said barrier means when the free-flying object travels through the sensing region.

9. The capture device according to claim 8, wherein the sensing system comprises a plurality of sensors, the sensors being mounted downstream of the barrier means with respect to an incoming direction of the free-flying body inside the capture volume.

10. The capture device according to claim 2, further comprising pushing means for pushing the free-flying body, so that the free-flying body passes through the outlet mouth.

11. The capture device according to claim 2, wherein
the inflatable primary body comprises a wall cooperating with the capture volume, and
capture device comprises inflatable guiding elements arranged along the wall of the inflatable primary body, the inflatable guiding elements being adapted to define a path for guiding the free-flying body towards the outlet mouth of the capture device.

12. The capture device according to claim 1, further comprising
a rearm system, for allowing a multi-capture operating mode of the capture device.

13. The capture device according to claim 6,
further comprising a rearm system, for allowing a multi-capture mode of the capture device,
wherein the rearm system comprises restoring means provided at least inside the inflatable arms, the restoring means being able to counteract the inflation of the inflatable arms.

14. A space apparatus including the capture device according to claim 1.

15. The space apparatus according to claim 14, wherein the space apparatus is a space vehicle.
